(19) United States
(12) Patent Application Publication
(10) Pub. No.: US 2009/0140693 A1
(43) Pub. Date: Jun. 4, 2009

(54) FLYBACK CHARGE REDISTRIBUTION APPARATUS FOR SERIALLY CONNECTED ENERGY STORAGE DEVICES USING FLYBACK-TYPE CONVERTERS

(75) Inventor: Robert William Johnson, JR., Raleigh, NC (US)

Correspondence Address: MYERS BIGEL SIBLEY & SAJOVEC, PO BOX 37428, RALEIGH, NC, 27627, US

(73) Assignee: Eaton Corporation

(21) Appl. No.: 12/266,902

(22) Filed: Nov. 7, 2008

Related U.S. Application Data
(60) Provisional application No. 60/991,231, filed on Nov. 30, 2007.

(51) Int. Cl. H02J 7/00

(52) U.S. Cl. 320/116

(57) ABSTRACT

A charge redistribution apparatus includes a transformer including a primary winding and a plurality of secondary windings. The apparatus also includes a plurality of rectifier circuits, respective ones of which are configured to connect respective ones of the secondary windings across respective groups of a plurality of serially connected energy storage devices (e.g., respective individual cells, respective batteries and/or respective strings of batteries). The apparatus further includes a switch configured to connect the primary winding across the plurality of serially connected energy storage devices, and a control circuit configured to control the switch. The control circuit may be configured to cause the switch to alternately connect and disconnect the primary winding to and from the string of serially connected energy storage devices to redistribute charge among the energy storage devices.

### CROSS-REFERENCE TO RELATED APPLICATION

This application claims priority to U.S. Provisional Application Ser. No. 60/991,231, filed Nov. 30, 2007, the disclosure of which is incorporated by reference in its entirety.

### BACKGROUND OF THE INVENTION

The invention relates to power conversion apparatus and methods and, more particularly, to apparatus and methods for redistributing charge among serially connected energy storage devices.

Battery strings including multiple serially connected cells are used in a variety of applications, such as in electric propulsion systems and backup power systems. For example, an electric or hybrid vehicle may use a battery pack including a large number of serially connected cells, e.g., lead-acid, nickel-metal-hydride (NiMH) or lithium ion cells, to provide electric power for vehicle propulsion. Large serially connected strings of cells may also be used in uninterruptible power supply (UPS) applications to provide backup power for, for example, data processing, telecommunications or medical equipment. Serially connected strings of other types of energy storage devices, such as capacitors and supercapacitors, may be used in a similar fashion.

Battery strings may undergo frequent charge/discharge cycles. Generally, it is desirable that the cells in a string are kept at a substantially uniform level of charge to reduce or prevent undercharging and/or overcharging of individual cells. Over the course of many charge/discharge cycles, however, cells in a string may reach a undesirably non-uniform state of charge, e.g., some cells in the string may substantially less charged than others while some cells may become overcharged.

A variety of techniques have been proposed for balancing charge levels among serially connected energy storage devices. Many of these approaches involve individually monitoring the state of charge of each of the devices in a string in order to determine relative levels of charge, and using switching networks to selectively route charge to achieve balance. Such approaches may not be desirable in high-capacity applications, such as vehicular and large-scale UPS applications, due to, among other things, limitations on the current-carrying capacity of such networks.

### SUMMARY OF THE INVENTION

In some embodiments of the present invention, a charge redistribution apparatus includes a transformer including a primary winding and a plurality of secondary windings. The apparatus also includes a plurality of rectifier circuits, respective ones of which are configured to connect respective ones of the secondary windings across respective groups of a plurality of serially connected energy storage devices (e.g., respective individual cells, respective batteries and/or respective strings of batteries). The apparatus further includes a switch configured to connect the primary winding across the plurality of serially connected energy storage devices, and a control circuit configured to control the switch.

The control circuit may be configured to cause the switch to alternately connect and disconnect the primary winding to and from the string of serially connected energy storage devices to redistribute charge among the energy storage devices. For example, the control circuit may be configured to operate the switch, transformer and rectifier circuits as a flyback converter. According to some embodiments, the control circuit may be configured to operate the switch in an active mode and to disable operation of the switch in an inactive mode, and to transition between the active mode and the inactive mode periodically and/or responsive to a state of the energy storage devices. A charger circuit may be configured to charge the string of serially connected energy storage devices, and the control circuit may operate responsive to the charger circuit.

In further embodiments, the rectifier circuits may include respective synchronous rectifier circuits. The transformer may further include an auxiliary winding and the apparatus may further include a monitor circuit coupled to the auxiliary winding. For example, the monitor circuit may include a load, a synchronous rectifier circuit configured to couple the auxiliary winding across the load and a voltage monitor circuit configured to determine a voltage across the load. The monitor circuit may be configured to selectively enable the synchronous rectifier circuits coupled to the energy storage devices to support monitoring of individual ones of the energy storage devices. A second primary winding coupled in series with a rectifier circuit across the string of energy storage devices may be included to improve efficiency.

Further embodiments of the present invention provide charge redistribution apparatus including a transformer including a primary winding, a plurality of secondary windings and an auxiliary winding. The apparatus also includes a plurality of rectifier circuits, respective ones of which are configured to connect respective ones of the secondary windings across respective groups of a plurality of serially connected energy storage devices, a switch configured to connect the primary winding across the plurality of serially connected energy storage devices, a control circuit configured to control the switch and a monitor circuit coupled to the auxiliary winding. The rectifier circuits may include respective synchronous rectifier circuits and the monitor circuit may include a load, a synchronous rectifier circuit configured to couple the auxiliary winding across the load and a voltage monitor circuit configured to selectively enable the synchronous rectifier circuits that couple the secondary windings to the energy storage devices and to monitor a voltage across the load responsive thereto.

### BRIEF DESCRIPTION OF THE DRAWINGS

FIG. 1 is a schematic diagram illustrating a charge redistribution apparatus and operations thereof according to some embodiments of the present invention.

FIG. 2 is a schematic diagram illustrating a charge redistribution apparatus and operations thereof according to additional embodiments of the present invention.

FIG. 3 is a schematic diagram illustrating a charge redistribution apparatus and operations thereof according to further embodiments of the present invention.

FIG. 4 is a schematic diagram illustrating a charge redistribution apparatus and operations thereof according to some embodiments of the present invention.

FIG. 5 is a schematic diagram illustrating a monitor circuit and operations thereof according to some embodiments of the present invention.

FIG. 6 is a schematic diagram illustrating a charge redistribution apparatus and operations thereof according to some embodiments of the present invention.

### DETAILED DESCRIPTION OF EXEMPLARY EMBODIMENTS

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As will be appreciated by one of skill in the art, the invention may be embodied as system and methods. Embodiments of the invention may include hardware and/or software. Embodiments of the invention include circuitry configured to provide functions described herein. It will be appreciated that such circuitry may include analog circuits, digital circuits, and combinations of analog and digital circuits.

Embodiments of the invention are described below with reference to block diagrams and/or operational illustrations of systems and methods according to various embodiments of the invention. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. In some implementations, the functions/acts noted in the figures may occur out of the order noted in the block diagrams and/or operational illustrations. For example, two operations shown as occurring in succession may, in fact, be executed substantially concurrently or the operations may sometimes be executed in the reverse order, depending upon the functionality/acts involved.

Some embodiments of the present invention arise from a realization that balancing of a string of cells or other energy storage devices (e.g., capacitors) may be achieved using a flyback type of power converter including a transformer having a primary winding switchably coupled across the string and a plurality of secondary windings, respective ones of which are coupled to respective groups of devices of the string by respective rectifier circuits. Use of such a circuit arrangement may provide for balancing of charge among the energy storage devices without requiring monitoring the state of charge of individual devices or the use of switching networks to direct current among the energy storage devices. In further embodiments, the rectifier circuits may be synchronous rectifier circuits, which may support more uniform balancing. In still further embodiments, a monitor circuit coupled to an auxiliary winding of the transformer may support selective monitoring of the energy storage devices.

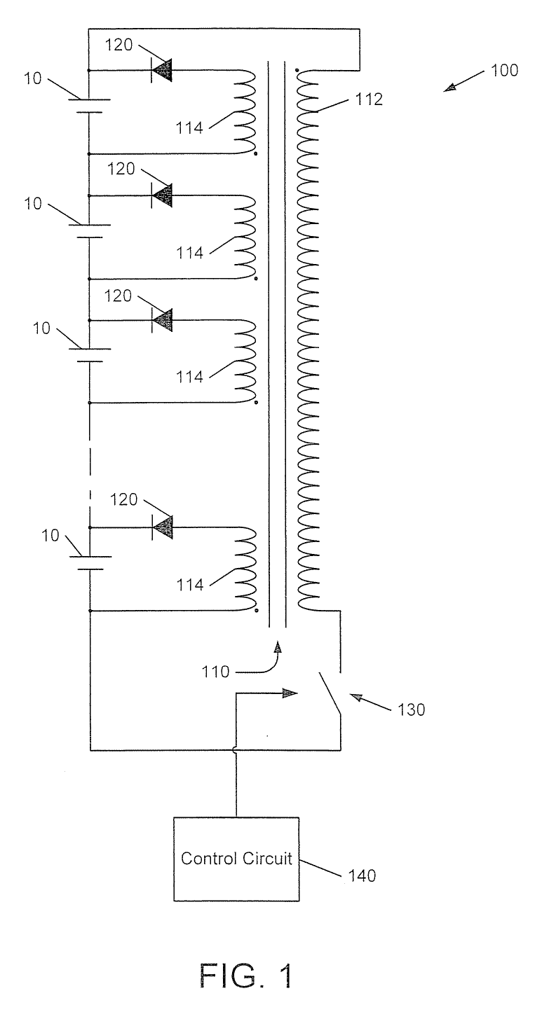

FIG. 1 illustrates a charge redistribution apparatus 100 and operations thereof according to some embodiments of the present invention. The apparatus 100 includes a transformer 110 including a primary winding 112 and a plurality of secondary windings 114 magnetically coupled to the primary winding 112. The secondary windings 114 have substantially identical turns. Respective rectifier circuits 120, e.g., diodes or active circuits configured to provide rectification, are configured to couple respective ones of the secondary windings 114 to respective groupings of serially connected cells 10. In particular, in the illustrated embodiments, the rectifier circuits 120 couple respective ones of the secondary windings 114 to respective ones of the cells 10. However, it will be appreciated that, in some embodiments, more than one cell may be coupled to each secondary winding 114. For example, respective ones of the secondary windings 114 and associated rectifier circuits 120 may be coupled across respective batteries (i.e., respective plural groupings of cells) or across respective ones of respective serially connected strings of batteries. It will be further appreciated that, in some embodiments, energy storage devices other than cells, such as capacitors or supercapacitors, may be used.

A switch 130, e.g., a semiconductor switching device, is coupled in series with the primary winding 112, and a control circuit 140 is configured to control operation of the switch 130 to support redistribution of charge among the cells 10. In some embodiments, the control circuit 140 may, for example, alternately open and close the switch 130 to operate the apparatus 100 as a flyback-type converter. In particular, when the switch 130 is closed, the primary winding 112 acts as an inductor, storing energy in the magnetic field of the transformer 110. When the switch 130 is opened, current ceases to flow in the primary winding 112, causing a voltage to develop across the primary winding 112 and, by virtue of the coupling of the transformer 110, across the secondary windings 114. As a result, current may flow to the cells 10 via the rectifier circuits 120. In particular, the lowest voltage cell(s) generally receives a relatively greater share of current as the energy stored in the transformer 110 is discharged, causing the cell(s) with the lowest voltage to increase in voltage and the cell(s) with the higher voltage to decrease in voltage. Thus, the string of cells 10 may be driven toward balance. The control circuits 140 may operate the apparatus 110 in a discontinuous mode, i.e., by waiting to recluse the switch 130 until after energy stored in the transformer is completely discharged, to reduce or minimize losses. It will be appreciated, however, that the apparatus 100 may be operated in a continuous mode, with potentially greater losses.

It will be appreciated that the circuitry of the apparatus 100 may be implemented in a number of different ways. For example, the control circuit 140 may, in general, be implemented using analog circuitry and/or digital circuitry, including such devices as microcontrollers, microprocessors or special purpose devices (e.g., ASICs). The rectifier circuits 120 may include, for example, diodes or other types of solid state switching devices, such as bipolar or field effect transistors. The transformer 110 may be arranged in a number of different ways, e.g., using different core materials, geometries, winding materials, and the like based on parameters such as voltage level, current capacity and switching frequency. Other circuitry, such as a snubber circuit, may be included to support operation of the switch 130.

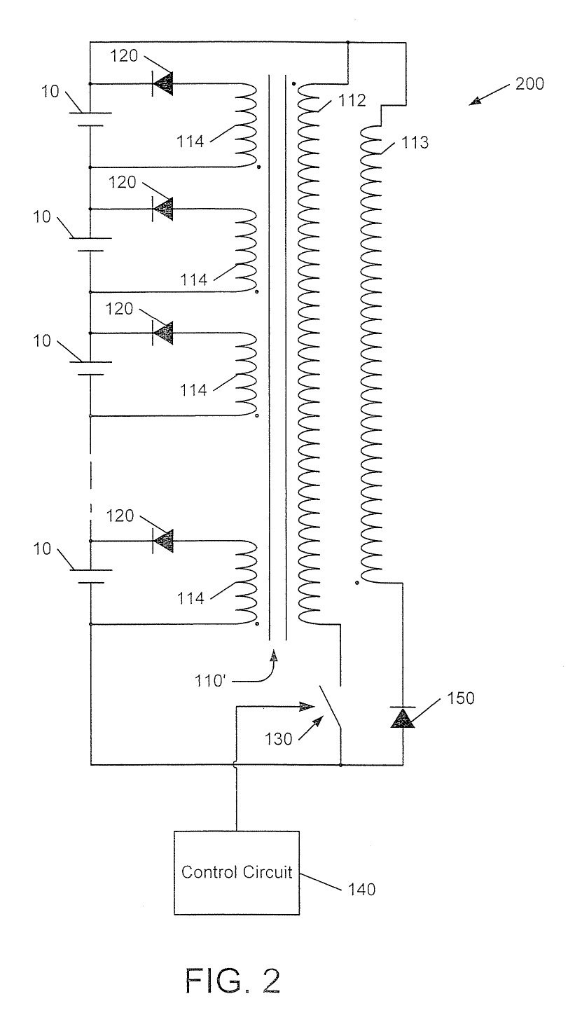

As shown in FIG. 2, a charge redistribution apparatus 200 according to further embodiments of the present invention may further include a second primary winding 113 coupled in series with a rectifier 150 across the string of cells 10. The second primary winding 113 may be wound tightly to the first primary winding 112, and may return magnetizing current that is not transferred to the secondary windings 114 to the string of cells 10. The use of the additional primary winding 113 may improve efficiency by returning energy to the cells 10 instead of dissipating it, for example, in a snubber.

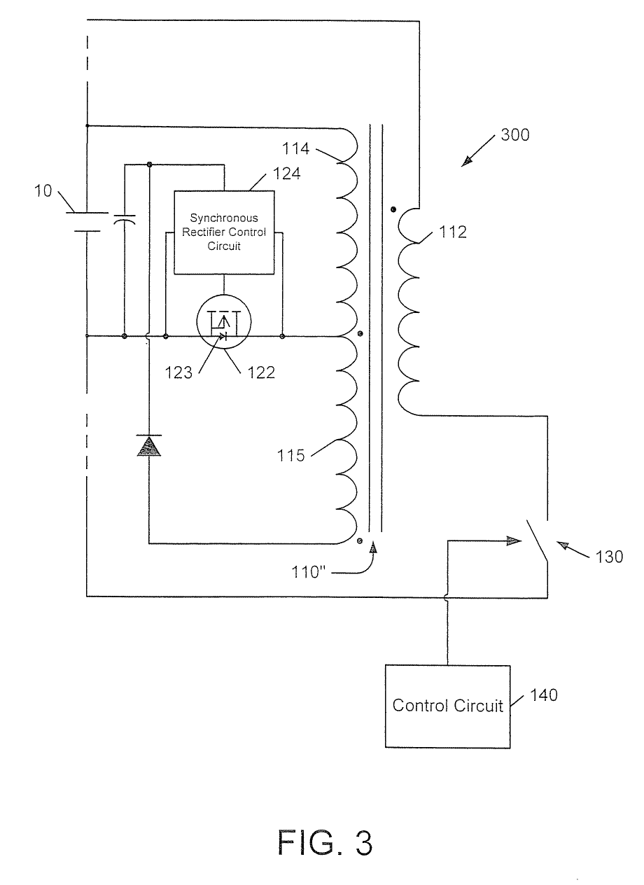

FIG. 3 illustrates a charge redistribution apparatus 300 according to additional embodiments of the present invention. The apparatus 300 includes a transformer 110″ with a primary winding 112, primary side switch 130 and control circuit 140 along lines discussed above with reference to FIGS. 1 and 2. A cell 10 of a string of cells is coupled to a secondary winding 114 of the transformer 110″ by a synchronous rectifier circuit including a field effect transistor (FET) 122 controlled by a synchronous rectifier control circuit 124.

The synchronous rectifier control circuit 124 may include, for example, a rectifier control integrated circuit (IC), such as the IR1167 SmartRectifier™ Control IC produced by International Rectifier. Such a device may include control circuitry that monitors a voltage across a body diode 123 of the FET 122, and generates a gate drive for the FET 122 responsive to the monitored voltage such that the FET 122 turns on when the body diode 123 becomes forward biased due to development of a voltage across the secondary winding 114. Turn on of the FET 122, which may have a relatively low “on” resistance, can reduce a voltage drop between the secondary winding 114 and the cell 10 when charge is being transferred to the cell 10. Use of such a synchronous rectifier circuit may also enable more uniform balancing of cells by removing variability in forward conduction voltages associated with the use of diode rectifiers. As further shown in FIG. 3, an auxiliary secondary winding 115 may be used to generate power for the synchronous rectifier control circuit 124. The synchronous rectifier circuitry, e.g., the FET 122, control circuit 124 and power supply circuitry, may be integrated with the cells 10.

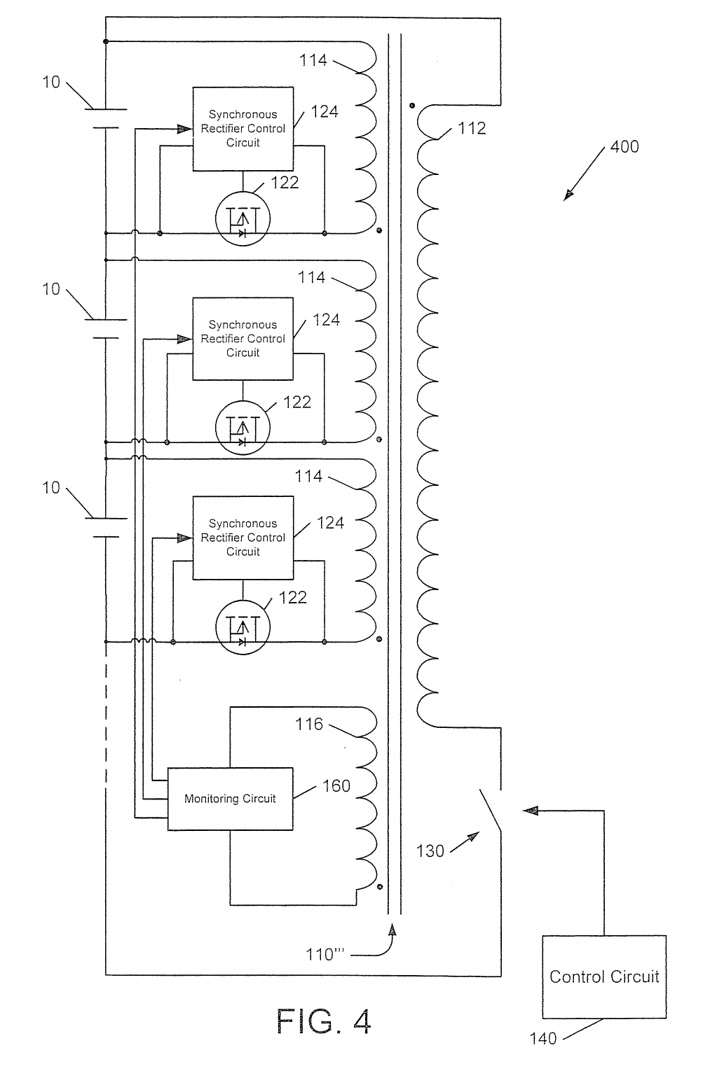

FIG. 4 illustrates a charge redistribution apparatus 400 according to further embodiments of the present invention. The apparatus 400 includes a transformer 110′″ including a primary winding 112 and secondary windings 114. A switch 130 is coupled in series with the primary winding 112 across a string of serially connected cells 10. Respective synchronous rectifier circuits including a FET 122 and control circuit 124 are configured to couple respective ones of the secondary windings 114 across respective ones of the cells 10. For clarity of illustration, power supply connections for the control circuits 124 are not shown but, for example, an arrangement along the lines discussed above with reference to FIG. 3 may be used.

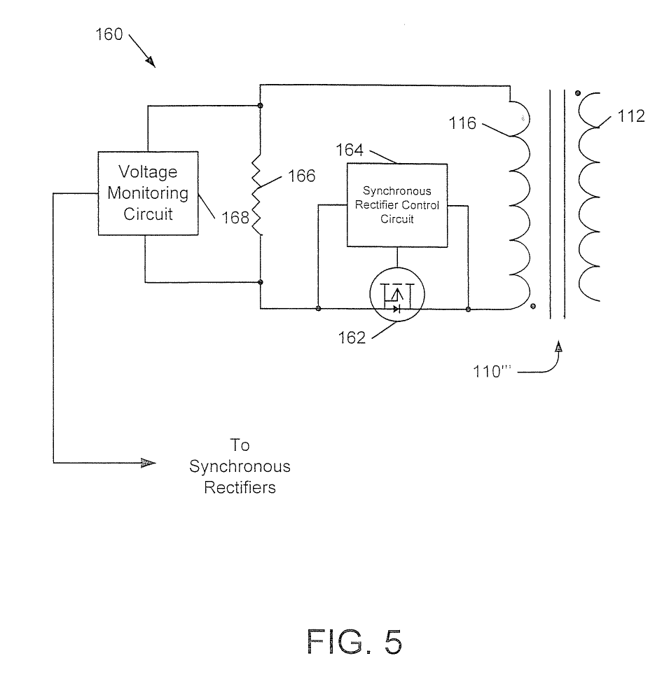

An auxiliary winding 116 is coupled to a monitoring circuit 160 that is configured to generate control signals to enable and disable the synchronous rectifier control circuits 124. For example, referring to FIG. 5, the monitoring circuit 160 may include a synchronous rectifier circuit including an FET 162 and control circuit 164, which are configured to control coupling of a load 166 to the auxiliary winding 116. A voltage monitor circuit 168 may monitor a voltage of the load 166 and responsively generate control signals for the synchronous rectifier circuits that are coupled to the cells 10.

It will be appreciated that the monitor circuits 160, 168 may, in general, be implemented using analog and/or digital circuitry, including such devices as microcontrollers, microprocessors or special purpose devices (e.g., ASICs). It will be further understood that functions of such monitor circuits may also be integrated with functions of the control circuit 140, e.g., in a common microprocessor, microcontroller or ASIC.

For example, in first mode, all of the control circuits 124 coupled to the cells 10 may be active and operational. In this mode, the voltage monitor circuit 168 may measure a voltage across the load 166 as indicative of the lowest cell voltage. In a second mode, the voltage monitor circuit 168 may determine voltages of each of the cells 10 in turn by inhibiting all but one of the control circuits 124 coupled to the cells 10 and measuring the voltage across the load 166, which is indicative of the voltage of the cell 10 coupled to the one active control circuit 124.

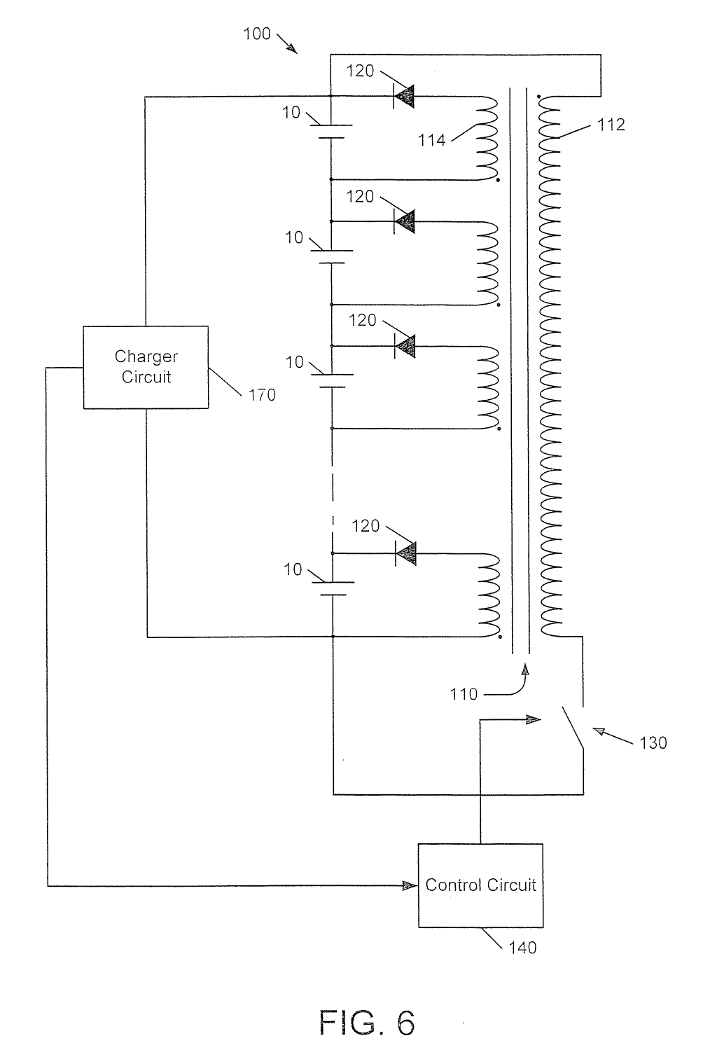

Charging of a string of cells may cause or exacerbate cell imbalance. According to some embodiments of the present invention, charge redistribution may be performed in conjunction with charging to reduce or eliminate imbalance brought about by charging. For example, as illustrated in FIG. 6, a control circuit 140 of a charge redistribution apparatus 100 along the lines of FIG. 1 may operate responsive to a charger circuit 170 that charges a string of cells 10. During a charging process, for example, the charge redistribution apparatus 100 may be operated at a fraction of the current delivered by the charger circuit 170 to maintain balance among the cells 10. For example, the charge redistribution apparatus 100 may discharge the string of cells 10 at a rate of 5% if the charging rate, returning the discharged current (minus losses) to selected cells of the string. Once the string of cells 10 is sufficiently charged and balanced, the control circuit 140 may transition the charge redistribution apparatus 100 to an inactive state in which the switch 130 is disabled and left in an open state.

According to further embodiments, the control circuit 140 may further intermittently transition the apparatus 100 between such an inactive mode and an active mode in which operation of the switch 130 is enabled to allow charge redistribution to compensate for imbalances that may develop among the cells 10, for example, as the string of cells 10 is discharged. For example, the control circuit 140 may periodically activate the apparatus 100 at predetermined times for predetermined durations and/or may activate the apparatus 100 responsive to a monitored state of the string of cells 10. For example, operation of the apparatus 100 may be conditioned upon measurements of the cells 10 made using monitoring circuitry along the lines described above with reference to FIGS. 4 and 5. For example, if such measurements detect an undesirable imbalance in voltage among the cells 10, the apparatus 100 may be activated to bring the cells 10 to a desirable balance.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed:

1. A charge redistribution apparatus comprising:
a transformer comprising a primary winding and a plurality of secondary windings;
a plurality of rectifier circuits, respective ones of which are configured to connect respective ones of the secondary windings across respective groups of a plurality of serially connected energy storage devices;
a switch configured to connect the primary winding across the plurality of serially connected energy storage devices; and
a control circuit configured to control the switch.

2. The apparatus of claim 1, wherein the control circuit is configured to cause the switch to alternately connect and disconnect the primary winding to and from the string of serially connected energy storage devices to redistribute charge among the energy storage devices.

3. The apparatus of claim 2, wherein the control circuit is configured to operate the switch, transformer and rectifier circuits as a flyback converter.

4. The apparatus of claim 2, wherein the control circuit is configured to operate the switch in an active mode and to disable operation of the switch in a inactive mode, and wherein the control circuit is configured to transition between the active mode and the inactive mode responsive to a charge or discharge state of the string of energy storage devices.

5. The apparatus of claim 1, wherein the rectifier circuits comprise respective synchronous rectifier circuits.

6. The apparatus of claim 5, wherein the transformer further comprises an auxiliary winding and wherein the apparatus further comprises a monitor circuit coupled to the auxiliary winding.

7. The apparatus of claim 6, wherein the monitor circuit comprises:
a load;
a synchronous rectifier circuit configured to couple the auxiliary winding across the load; and
a voltage monitor circuit configured to determine a voltage across the load.

8. The apparatus of claim 6, wherein the monitor circuit is configured to selectively enable the synchronous rectifier circuits.

9. The apparatus of claim 1, further comprising a charger circuit configured to charge the string of serially connected energy storage devices, and wherein the control circuit operates responsive to the charger circuit.

10. The apparatus of claim 1, wherein respective ones of the groups of energy storage devices comprises respective individual cells, respective batteries and/or respective strings of batteries.

11. The apparatus of claim 1, further comprising a rectifier circuit coupled in parallel with the primary winding.

12. The apparatus of claim 1, wherein the rectifier circuits comprise respective diodes coupled in series with the secondary windings.

13. The apparatus of claim 1, wherein the secondary windings have substantially identical numbers of turns.

14. A charge redistribution apparatus comprising:
a transformer comprising a primary winding, a plurality of secondary windings and an auxiliary winding;
a plurality of rectifier circuits, respective ones of which are configured to connect respective ones of the secondary windings across respective groups of a plurality of serially connected energy storage devices;
a switch configured to connect the primary winding across the plurality of serially connected energy storage devices;
a control circuit configured to control the switch; and
a monitor circuit coupled to the auxiliary winding.

15. The apparatus of claim 14, wherein the control circuit is configured to cause the switch to alternately connect and disconnect the primary winding to and from the string of serially connected energy storage devices to redistribute charge among the energy storage devices.

16. The apparatus of claim 14:
wherein the rectifier circuits comprise respective synchronous rectifier circuits; and
wherein the monitor circuit comprises:
a load;
a synchronous rectifier circuit configured to couple the auxiliary winding across the load; and
a voltage monitor circuit configured to selectively enable the synchronous rectifier circuits that couple the secondary windings to the energy storage devices and to monitor a voltage across the load responsive thereto.

17. The apparatus of claim 14, wherein respective ones of the groups of energy storage devices comprises respective individual cells, respective batteries and/or respective strings of batteries.

18. The apparatus of claim 14, wherein the rectifier circuits comprise respective diodes coupled in series with the secondary windings.

19. The apparatus of claim 13, wherein the secondary windings have substantially identical numbers of turns.
